(19) United States
(12) Patent Application Publication
(10) Pub. No.: US 2022/0227479 A1
(43) Pub. Date: Jul. 21, 2022

(54) FLYING BODY, CONTROL METHOD, AND PROGRAM

(71) Applicant: SONY GROUP CORPORATION, Tokyo (JP)

(72) Inventor: Koichi HAYAKAWA, Tokyo (JP)

(73) Assignee: SONY GROUP CORPORATION, Tokyo (JP)

(21) Appl. No.: 17/615,392

(22) PCT Filed: May 8, 2020
(86) PCT No.: PCT/JP2020/018646

§ 371 Date: Nov. 30, 2021

(30) Foreign Application Priority Data
Jul. 4, 2019 (JP) 2019-125225

(51) Int. Cl. B64C 13/18; B64C 27/08; B64C 39/02; G08G 5/02; G01P 13/00

(52) U.S. Cl. CPC B64C 13/18; B64C 27/08; G01P 13/00; G08G 5/02; B64C 39/024

(57) ABSTRACT

A flying body includes a control unit configured to set a horizontal ground speed on the basis of wind information including information about a wind direction and a wind speed.

### TECHNICAL FIELD

The present disclosure relates to a flying body, a control method, and a program.

### BACKGROUND ART

Recently, unmanned autonomous flying bodies called unmanned aerial vehicles (UAVs) or drones (hereinafter appropriately referred to as a drone) have been used in various situations such as various types of photographing, observation, and disaster relief. Accordingly, various control methods for drones have been proposed (refer to PTL 1, for example).

### CITATION LIST

### Patent Literature

[PTL 1]
JP 2018-52341 A

### SUMMARY

### Technical Problem

In general, an attitude of a drone at the time of landing is affected by wind and thus easily becomes unstable. Accordingly, there is need for control of an attitude of a drone such that the drone can land in a stable attitude even in a case where the drone is affected by wind.

The present disclosure has been devised in view of the above-described circumstances and an objective of the present disclosure is to provide a flying body controlled to land in a stable attitude even in a case where the flying body is affected by wind, a control method, and a program.

### Solution to Problem

The present disclosure is, for example, a flying body including a control unit configured to set a horizontal ground speed on the basis of wind information including information about a wind direction and a wind speed.

The present disclosure is, for example, a control method in a flying body, including setting, by a control unit, a horizontal ground speed on the basis of wind information including information about a wind direction and a wind speed.

The present disclosure is, for example, a program causing a computer to execute a control method in a flying body, including setting, by a control unit, a horizontal ground speed on the basis of wind information including information about a wind direction and a wind speed.

### BRIEF DESCRIPTION OF DRAWINGS

FIG. 1 is a diagram that will be referred to when problems to be considered in an embodiment are described.

FIG. 2 is a diagram that will be referred to when problems to be considered in an embodiment are described.

FIG. 3 is a diagram referred to when an overview of an embodiment is described.

FIG. 4 is a diagram referred to when an overview of an embodiment is described.

FIG. 5 is a diagram referred to when an overview of an embodiment is described.

FIG. 6A to FIG. 6C are diagrams that will be referred to when an example of a wind information estimation method is described.

FIG. 7 is a block diagram illustrating a configuration example of a drone according to a first embodiment.

FIG. 8 is a flowchart illustrating a flow of processing performed in the drone according to the first embodiment.

FIG. 9 is a block diagram illustrating a configuration example of a drone according to a second embodiment.

FIG. 10 is a flowchart illustrating a flow of processing performed in the drone according to the second embodiment.

FIG. 11 is a flowchart illustrating a flow of processing performed in a drone according to a third embodiment.

FIG. 12 is a block diagram illustrating a configuration example of a drone according to a fourth embodiment.

FIG. 13 is a flowchart illustrating a flow of processing performed in the drone according to the fourth embodiment.

### DESCRIPTION OF EMBODIMENTS

Hereinafter, embodiments of the present disclosure will be described with reference to the drawings. The description will be made in the following order.

<Problems to be considered in embodiments>

<Overview of embodiments>

<First Embodiment>

<Second Embodiment>

<Third Embodiment>

<Fourth Embodiment>

<Modified examples>

The embodiments to be described below are preferred specific examples of the present disclosure and content of the present disclosure is not limited to the embodiments.

### Problems to be Considered in Embodiments

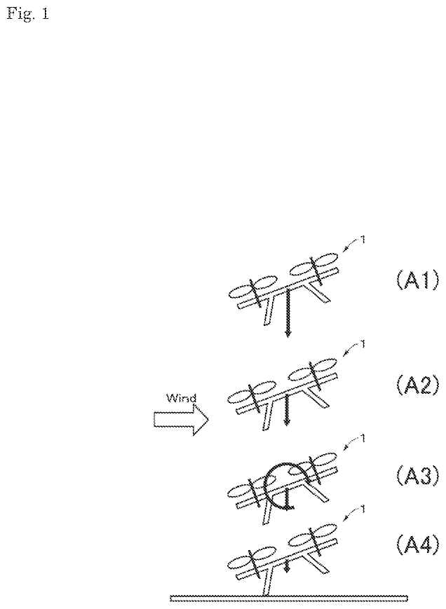

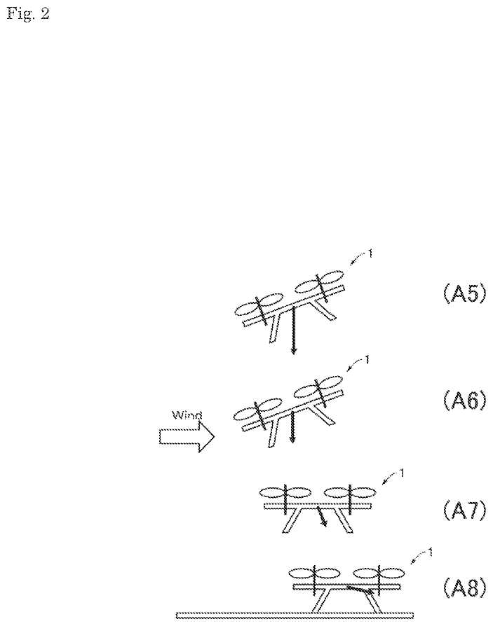

First, to facilitate understanding of the present disclosure, problems to be considered in embodiments will be described with reference to FIG. 1 and FIG. 2.

FIG. 1 is a diagram schematically illustrating a state in which a drone 1 is landing. In the example illustrated in FIG. 1, the wind is blowing from the left to the right with respect to the drone 1 in the figure. For stable landing of the drone 1, it is desirable that a horizontal ground speed of the drone 1 become 0 or a value close to 0 at the time of landing. When the drone 1 is caused to vertically descend, a method of causing the drone 1 to fly at the same speed as that of the wind in a direction reverse to the wind such that the horizontal ground speed becomes 0 near the ground surface is conceived. When such control is performed, an attitude of the drone 1 inclines to the windward side (a state represented by reference signs A1 and A2 in FIG. 1). Then, a side of the airframe of the drone 1 close to the ground is subjected to a considerable ground effect at the time of approaching the ground surface, causing generation of rotation moment (a state represented by reference sign A3 in FIG. 1). Due to generation of the rotation moment, attitude control of the drone 1 becomes difficult. Furthermore, since the drone 1 lands in an inclined state, the drone 1 may overturn at the time of landing (a state represented by reference sign A4 in FIG. 1).

Accordingly, as illustrated in FIG. 2, control of causing the drone 1 to vertically descend (a state represented by reference signs A5 and A6 in FIG. 2) and making the airframe horizontal in a state in which the drone 1 has approached the ground surface (a state represented by reference sign A7 in FIG. 2) is conceived. However, when the attitude of the drone 1 significantly changes near the ground surface, the attitude of the drone 1 easily becomes unstable. Furthermore, the drone 1 sways in the wind according to change in the attitude thereof, and thus landing may become unstable because the drone 1 maintains a horizontal ground speed. Based on the above description, control for landing the drone 1 in a stable state is performed in embodiments of the present disclosure.

### Overview of Embodiments

Next, an overview of embodiments of the present disclosure will be described. In the present description, common matters in embodiments will also be described.

### Overview of Embodiments

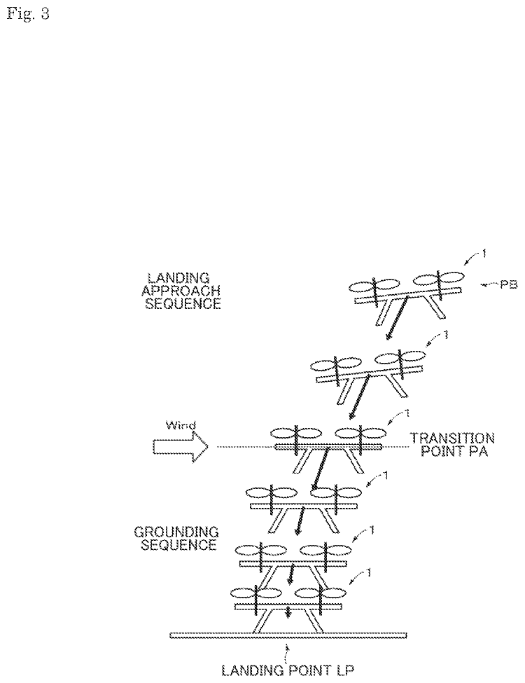

FIG. 3 is a diagram for describing an overview of embodiments. It is assumed that the drone 1 lands at a landing point LP illustrated in FIG. 3. The landing point LP may be a position of preset coordinates or a position of coordinates instructed by an appropriate apparatus on the ground (hereinafter appropriately referred to as a ground station). A transition point PA is set at an appropriate position in the space, as illustrated in FIG. 3. The transition point PA is a point positioned above the landing point LP and a point at which the drone starts a landing operation. The drone 1 present at a position in a certain space (above the transition point PA) determines to land. For example, the drone 1 determines to land by itself according to an instruction through a remote controller, completion of a given task, reduction in remaining capacity of a battery, malfunction of a sensor included in the drone 1, occurrence of communication failure, and the like.

When landing is determined, the drone 1 acquires wind information. The wind information includes information about the wind that affects flight of the drone and includes information about a wind direction and a wind speed. Such wind information may be acquired through a sensor included in the drone 1 or may be transmitted from a ground station to the drone 1.

The drone 1 determines a landing approach sequence and a grounding sequence. The landing approach sequence is control for the drone 1 performed from a current position (PB in FIG. 3) of the drone 1 to the transition point PA. A specific example of the landing approach sequence is information representing chronological positions of the drone 1 from the current point PB to the transition point PA and a speed of the drone 1 at each position. Here, for stable landing of the drone 1, it is desirable that a horizontal ground speed at the time of landing be approximately 0. Approximately 0 means that the horizontal ground speed is 0 or close enough to 0 for the drone 1 to safely land. Accordingly, at the transition point PA, control of assigning a horizontal ground speed to the drone 1 in advance such that the horizontal ground speed of the drone 1 becomes approximately 0 at the landing point LP is performed in the landing approach sequence. Specifically, rotation speeds of a plurality of motors included in the drone are controlled such that the horizontal ground speed of the drone becomes a set horizontal ground speed. A movement trajectory of the drone 1 from the current point PB to the transition point PA and a horizontal ground speed at each position are calculated such that a predetermined horizontal ground speed is assigned at the transition point PA, and the operation of the drone 1 is appropriately controlled on the basis of a calculation result.

The grounding sequence is control for the drone 1 performed from the transition point PA to the landing point LP. When the drone 1 detects that it has passed through the transition point PA, the drone 1 is controlled according to the grounding sequence. The grounding sequence is, for example, information representing chronological positions until landing and a vertical speed at each position. Meanwhile, control of making the attitude of the drone 1 horizontal or a horizontal ground speed at each position is defined in the grounding sequence. The drone 1 descends toward the landing point LP by being controlled on the basis of the grounding sequence, as illustrated in FIG. 3. Since the horizontal ground speed becomes approximately 0 at the time of landing in a state in which the airframe of the drone 1 has become horizontal, it is possible to curb inclining of the airframe of the drone 1 and cause the drone 1 to land in a stabilized attitude.

### Common Matters in Embodiments

(Transition Height)

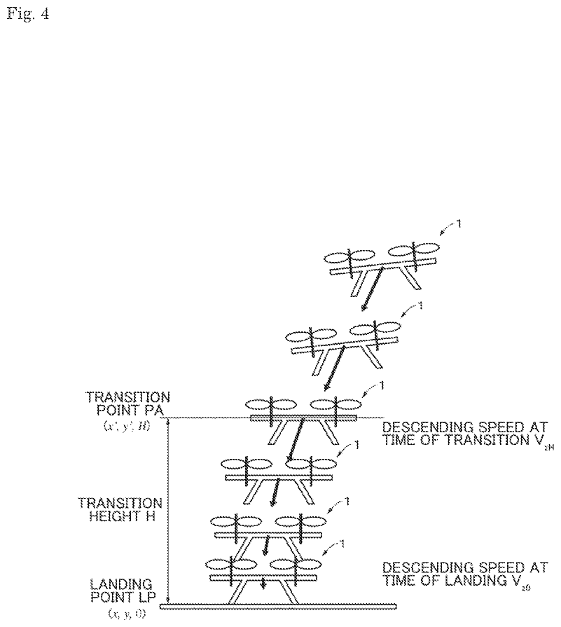

Next, common matters in embodiments will be described. First, a transition height H that is a height from the landing point LP to the transition point PA will be described. Meanwhile, coordinates of the landing point LP are denoted by (x, y, 0) and coordinates of the transition point PA are denoted by (x′, y′, H) (refer to FIG. 4).

When the transition height is H, a descending speed of the drone 1 is v_{z}(t), a time from a transition point is t, a time taken to land is tₜ, a downward speed of the drone 1 at the transition point PA (hereinafter appropriately referred to as a descending speed at the time of transition) is v_{z}(0)=v_{zH}, and a downward speed of the drone 1 at the time of landing (hereinafter appropriately referred to as a descending speed at the time of landing) is v_{z}(tₜ)=v_{z0} (refer to FIG. 4), this relation is represented by the following mathematical formula 1.

$$H = {\int }_{0}^{{t}_{t}} {v}_{z} ( t ) dt \qquad [ Math . 1 ]$$

Particularly, when the descending speed decreases at a constant rate, the aforementioned integration is analytically solved and represented by the following mathematical formula 2.

H=½(v_{zH}−v_{z0})·tₜ [Math. 2]

A descending speed at the time of landing is set to a speed no higher than a descending speed at which a drone can safely land. When the descending speed at the time of landing is set to 0 or considerably close to 0, the drone is likely to be unable to ground in the case of large position error, and thus the descending speed at the time of landing is set to a speed within a range in which the drone can safely land. The descending speed at the time of landing may be set depending on specifications of an airframe. Furthermore, a transition height may be set to an approximate indication according to a size of an airframe (e.g., about several times the diameter of the airframe). In such a case, a height set to the transition height H may be used. As an example, the transition height H is calculated by approximately adjusting the descending speed at the transition v_{zH} and the time tₜ.

(Horizontal Ground Speed)

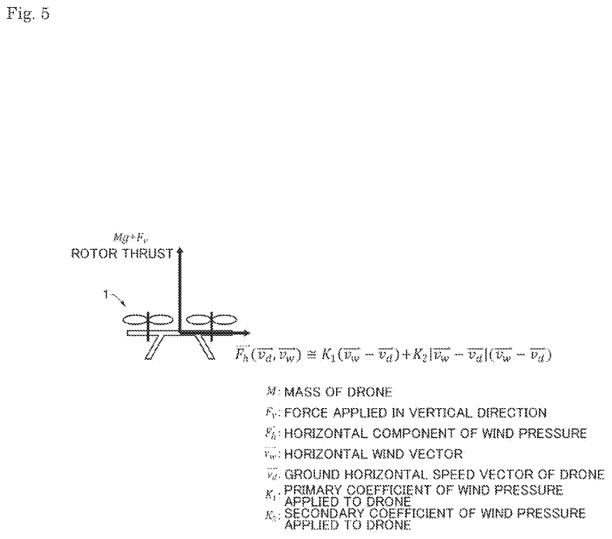

Next, a horizontal ground speed will be described. When the mass of the drone 1 is M and the acceleration of gravity thereof is g, the rotor thrust of the drone 1 can be represented by (Mg+Fᵥ) (refer to FIG. 5). Further, a horizontal force

[symbol]

(\vec{v}_{d},\vec{v}_{w})

which is a horizontal component of a wind pressure is received according to the wind in the horizontal direction.

[symbol]

is a horizontal ground speed vector of the drone 1. In addition,

[symbol]

is a wind vector in the horizontal direction.

The horizontal ground speed vector

[symbol]

of the drone 1 is represented by the following differential equation from the equation of motion.

[symbol]

= [symbol] (\vec{v}_{d},\vec{v}_{w})/M

If the aforementioned equation is solved under the condition that the horizontal ground speed of the drone 1 at the grounding time tₜ is 0 and

\vec{v}_{d}(tₜ)=0,

the horizontal ground speed

\vec{v}_{d}(0)

of the drone 1 at the transition point PA can be obtained.

Although

[symbol]

(\vec{v}_{d},\vec{v}_{w})

needs to be clear for the aforementioned equation, it can be approximated according to the following mathematical formula 3.

[symbol]

≅K₁( [symbol] − [symbol] )+K₂| [symbol] − [symbol] |( [symbol] − [symbol] ) [Math. 3]

K₁ and K₂ are primary and secondary constants of a wind pressure applied to the drone 1. K₁ and K₂ can be obtained in advance according to experiments, simulations, or the like. When only a component parallel to the wind in speeds of the drone 1 is taken, an equation represented by the following mathematical formula 4 is acquired.

$${\dot{ν}}_{d} = \frac{{K}_{1}}{M} ( {v}_{w} - {v}_{d} ) + \frac{{K}_{2}}{M} {( {ν}_{w} - {v}_{d} )}^{2} \qquad [ Math . 4 ]$$

If the aforementioned mathematical formula 4 is numerically solved or analytically solved by approximating K₂ to K₂=0, a horizontal ground speed

\vec{v}_{d}(0)

of the drone 1 necessary at the transition point PA can be obtained.

Such a horizontal ground speed is set by a control unit included in a drone according to each embodiment. Meanwhile, when the horizontal ground speed of the drone 1 is determined, horizontal coordinates (x′, y′) of the transition point PA are determined by performing integration or the like on the horizontal ground speed. Then, it is combined with the transition height H determined as described above and thus the coordinates (x′, y′, H) of the transition point PA are determined.

(Wind Information Estimation Method)

Next, a wind information estimation method will be described. In the present description, an example in which wind information is acquired by the drone 1 (multicopter) is described.

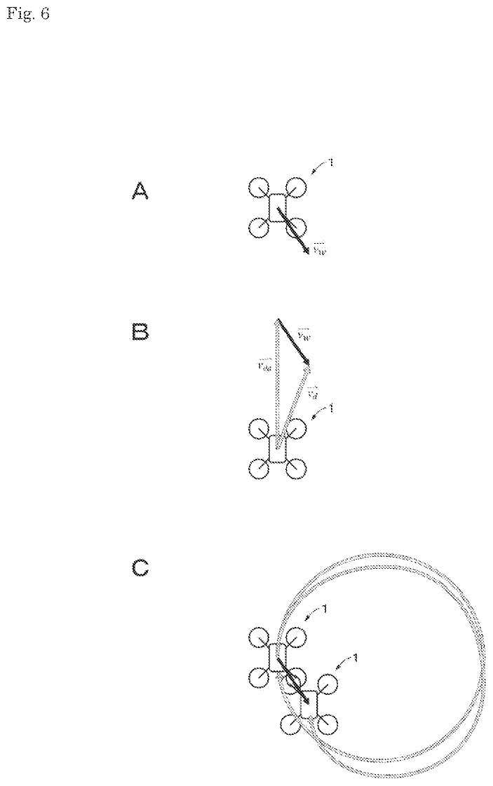

As a method of estimating wind information, the drone 1 is maintained horizontal and the airspeed of the drone 1 is set to 0, as schematically illustrated in FIG. 6A. Since a ground speed

[symbol]

of the airframe at that time becomes equal to a wind vector

[symbol]

,

this value is set as wind information.

As another method of estimating wind information, a wind vector

[symbol]

is estimated by vector-subtracting a ground speed

[symbol]

of the airframe from an airspeed

[symbol]

estimated according to a speedometer mounted in the drone 1 or airframe attitude (refer to FIG. 6B). An estimation result is set as wind information.

When uncertainty of estimation of a ground speed is high, the drone 1 flies along a course returning to a start point atmospherically (refer to FIG. 6C) and a wind direction and a wind speed are estimated from a difference between airspeeds at the start point and an end point. Accordingly, it is possible to cancel uncertainty of an airspeed estimate value.

In addition to the above-described methods, wind information may also be estimated on the basis of change in a position of simultaneous localization and mapping (SLAM) performed in the drone 1, the attitude of the drone 1, and motor output. In addition, wind information may be estimated on the basis of differences between a Global Positioning System (GPS) position of the drone 1 and the attitude of the drone 1 and motor output. Wind information may be estimated or measured by a ground station that is an external apparatus or another drone. Then, the measured wind information may be transmitted from the ground station to the drone 1 and acquired by a wind information acquisition unit. Further, wind information may be input by a user through a user interface (UI) and the input wind information may be transmitted to the drone 1.

### First Embodiment

[Example of Internal Configuration of Drone]

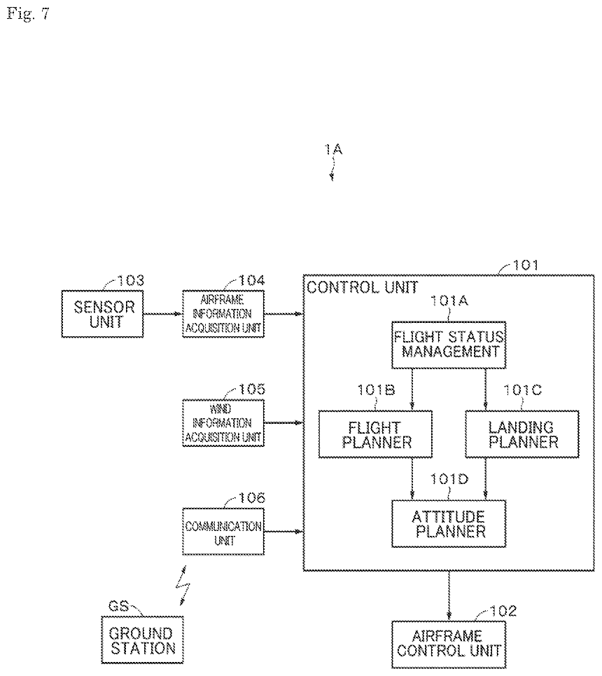

FIG. 7 is a block diagram illustrating an example of an internal configuration of a drone (hereinafter appropriately referred to as a drone 1A) according to a first embodiment. For example, the drone 1A includes a control unit 101, an airframe control unit 102, a sensor unit 103, an airframe information acquisition unit 104, a wind information acquisition unit 105, and a communication unit 106. The control unit 101 includes a flight status management unit 101A, a flight planner 101B, a landing planner 101C, and an attitude planner 101D as functional blocks.

The control unit 101 integrally controls the drone 1A. The flight status management unit 101A integrally manages flight statuses of the drone 1A and switches between control according to the flight planner 101B and control according to the landing planner 101C depending on a flight status. The flight planner 101B generates a flight course plan of the drone 1A. The flight course plan is information in which chronological positions through which the drone 1A flies and speeds at the positions are defined. The flight course plan may be set in advance or set by the flight planner 101B according to a task assigned to the drone 1A, or the like. The flight planner 101B outputs the flight course plan to the attitude planner 101D.

The landing planner 101C generates an approach course plan and a grounding course plan. The approach course plan is information in which chronological positions from a current position of the drone 1A to the transition point PA and speeds at the positions are defined. In addition, the grounding course plan according to the present embodiment is information in which attitudes, chronological positions, and vertical speeds at the positions from the transition point PA to the landing point LP are defined. The landing planner 101C outputs the approach course plan and the grounding course plan to the attitude planner 101D.

The attitude planner 101D generates airframe control information depending on the flight course plan applied from the flight planner 101B and the approach course plan and the grounding course plan applied from the landing planner 101C. The attitude planner 101D generates, for example, airframe control information of the drone 1A for causing the drone 1A to reach positions and speeds (specifically ground speeds in all directions) at the positions defined in the flight course plan. The attitude planner 101D determines, for example, airframe control information including attitudes, vertical accelerations, and the like in consideration of differences in positions and speeds of the airframes according to the flight course plan.

Further, the attitude planner 101D generates, for example, airframe control information of the drone 1A for causing the drone 1A to reach positions and speeds (specifically ground speeds in all directions) at the positions defined in the approach course plan. In addition, the attitude planner 101D generates, for example, airframe control information of the drone 1A for causing the drone 1A to reach positions, vertical speeds at the positions, and attitudes defined in the grounding course plan. The attitude planner 101D outputs the airframe control information to the airframe control unit 102. Meanwhile, the attitude planner 101D generates, for example, airframe control information for controlling attitudes of the drone 1A such that attitudes assigned according to the grounding course plan are realized without correcting horizontal positions and horizontal speeds of the airframe of the drone 1A according to the grounding course plan.

The airframe control unit 102 performs control in response to the airframe control information supplied from the attitude planner 101D. The airframe control unit 102 controls rotation speeds of motors included in the drone 1A such that the drone 1A has attitudes and speeds according to the airframe control information.

The sensor unit 103 is named with a generic term for a plurality of sensors for acquiring airframe information of the drone 1A (e.g., a current position, speeds, attitudes, and the like of the drone 1A). Sensors constituting the sensor unit 103 may include a GPS, an SLAM sensor, an acceleration sensor, a gyro sensor, an atmospheric pressure sensor, and the like.

The airframe information acquisition unit 104 appropriately converts sensing data input from the sensor unit 103 from analog data into digital data. Then, the airframe information acquisition unit 104 outputs the sensing data converted into the digital data to the control unit 101.

The wind information acquisition unit 105 acquires wind information and outputs the acquired wind information to the control unit 101. Since specific examples of wind information estimation methods have been described, repeated description is omitted.

The communication unit 106 allows the drone 1A to communicate with other apparatuses. The communication unit 106 includes a modulation/demodulation circuit and the like according to a communication method. The communication unit 106 performs, for example, communication with a ground station GS. According to such communication, for example, wind information transmitted from the ground station GS is received by the communication unit 106. The communication unit 106 outputs the received wind information to the control unit 101.

[Flow of Processing]

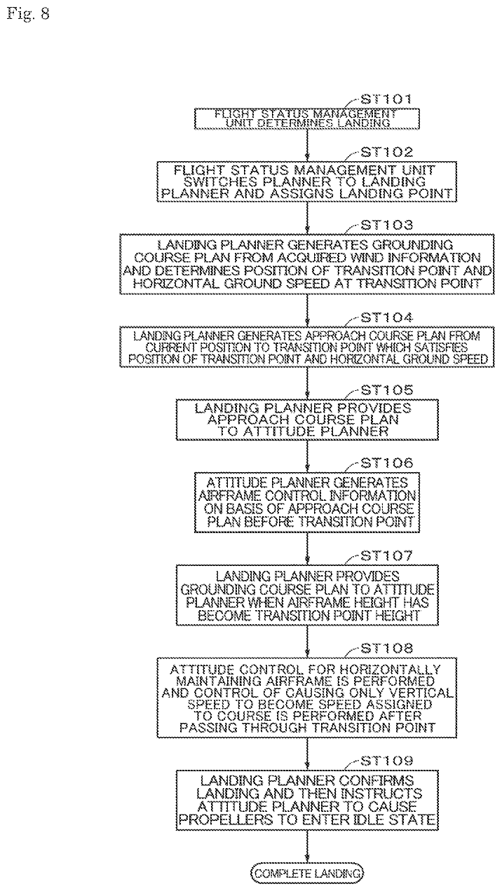

FIG. 8 is a flowchart illustrating a flow of processing performed in the drone 1A according to the first embodiment.

The flight status management unit 101A determines landing in step ST101. As described above, the flight status management unit 101A determines landing according to instruction from a remote controller, completion of an assigned task, reduction in the remaining capacity of a battery, malfunction of a sensor included in the drone 1, occurrence of communication failure, or the like. Although not shown, the drone 1A is flying on the basis of a flight course plan according to the flight planner 101B before step ST101. Then, processing proceeds to step ST102.

The flight status management unit 101A switches planners from the flight planner 101B to the landing planner 101C in step ST102. In addition, the flight status management unit 101A applies coordinates of a landing point LP to the landing planner 101C. Then, processing proceeds to step ST103.

In step ST103, the landing planner 101C acquires wind information. The wind information may be estimated by the drone 1A or transmitted from the ground station GS. Then, the landing planner 101C generates a grounding course plan from the acquired wind information. Specifically, the landing planner 101C sets a horizontal ground speed of the drone 1A on the basis of the acquired wind information and determines a position of a transition point PA on the basis of the horizontal ground speed. A specific method of setting a horizontal ground speed has been described above. In addition, the landing planner 101C generates a grounding course plan including an attitude (horizontal in the present example) at the transition point PA, chronological positions from the transition point PA to the landing point LP, vertical accelerations at the positions, and the like. Then, processing proceeds to step ST104.

In step ST104, the landing planner 101C generates an approach course plan from a current position to the transition point PA such that the position of the transition point PA and a speed of the drone 1A at the transition point PA correspond to the horizontal ground speed determined in step ST103. Then, processing proceeds to step ST105.

In step ST105, the landing planner 101C provides the approach course plan to the attitude planner 101D. Then, processing proceeds to step ST106.

In step ST106, the attitude planner 101D generates airframe control information based on the approach course plan before the transition point PA. The drone 1A moves to a position defined in the approach course plan according to the airframe control unit 102 operating on the basis of the generated airframe control information. Further, the motors of the drone 1A rotates to reach a speed defined in the approach course plan according to the airframe control unit 102 operating on the basis of the generated airframe control information. Then, processing proceeds to step ST107.

In step ST107, it is determined that an airframe height has reached the height of the transition point PA. For example, the flight status management unit 101A determines that the airframe height of the drone 1A has reached the height of the transition point PA on the basis of sensing data input from the sensor unit 103. The flight status management unit 101A notifies the landing planner 101C that the airframe height of the drone 1A has reached the height of the transition point PA. The landing planner 101C that has received the notification provides the grounding course plan generated in step ST103 to the attitude planner 101D. Then, processing proceeds to step ST108.

In step ST108, the attitude planner 101D generates airframe control information based on the grounding course plan. The grounding course plan in the present example is information for causing an attitude to be horizontal and information about vertical accelerations. Accordingly, the attitude planner 101D that has received the grounding course plan generates airframe control information for maintaining the attitude of the drone 1A horizontal after passing through the transition point PA and airframe control information including vertical speeds. Then, the attitude planner 101D outputs the generated airframe control information to the airframe control unit 102. The drone 1A descends at a predefined speed while maintaining the attitude thereof horizontal according to the airframe control unit 102 operating on the basis of the airframe control information. Then, processing proceeds to step ST109.

In step ST109, the landing planner 101C instructs the attitude planner 101D to cause propellers of the drone 1A to enter an idle state while checking landing of the drone 1A. The attitude planner 101D generates airframe control information based on such instruction. The attitude planner 101D outputs the generated airframe control information to the airframe control unit 102. The propellers of the drone 1A enter an idle state according to the airframe control unit 102 operating on the basis of the airframe control information. The idle state means a state in which the propellers of the drone 1A are rotated at a predetermined rotation speed or less (a degree of rotation speed at which the airframe of the drone 1A does not ascend). When the propellers of the drone 1A enter the idle state, a user can confirm that the drone 1A is not destroyed. Meanwhile, the propellers of the drone 1A may stop instead of entering the idle state.

According to the above-described first embodiment, a horizontal ground speed is assigned to the drone 1A in advance at the transition point PA such that a horizontal ground speed at the time of landing becomes 0 or approximately 0. Furthermore, the attitude of the drone 1A is controlled to be horizontal after the transition point PA. Accordingly, it is possible to stably land the drone 1A.

### Second Embodiment

Next, a second embodiment will be described. In description of the second embodiment, the same reference numerals are given to the same or homogeneous components as the above-described components and repeated description will be appropriately omitted. The matters described in the first embodiment can be applied to the second embodiment unless otherwise mentioned.

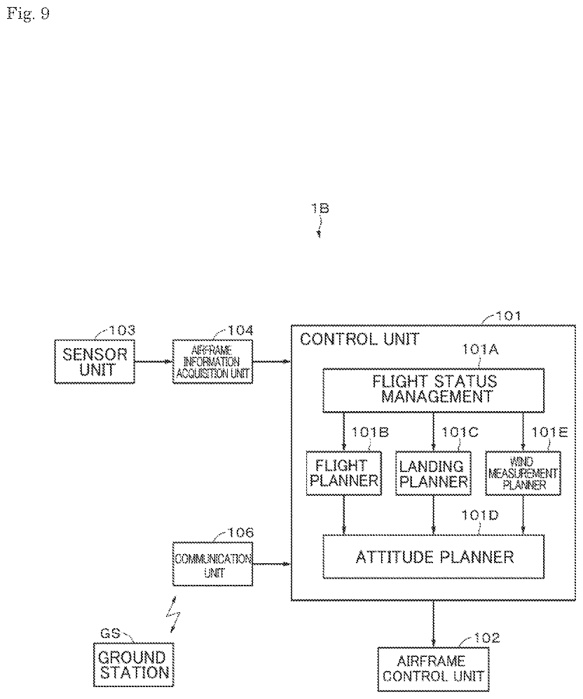

FIG. 9 is a block diagram illustrating a configuration example of a drone (hereinafter appropriately referred to as a drone 1B) according to a second embodiment. The drone 1B differs from the drone 1A in that the drone 1B does not include the wind information acquisition unit 105 and the control unit 101 includes a wind measurement planner 101E with respect to the configuration.

The wind measurement planner 101E generates a course plan for acquiring wind information. The wind measurement planner 101E outputs the generated course plan to the attitude planner 101D. The attitude planner 101D generates airframe control information for causing the drone 1B to move along the course plan supplied from the wind measurement planner 101E or causing the speed of the drone 1B to become a speed according to the course plan. The attitude planner 101D outputs the generated airframe control information to the airframe control unit 102. The course plan generated by the wind measurement planner 101E is realized according to the airframe control unit 102 operating on the basis of the airframe control information.

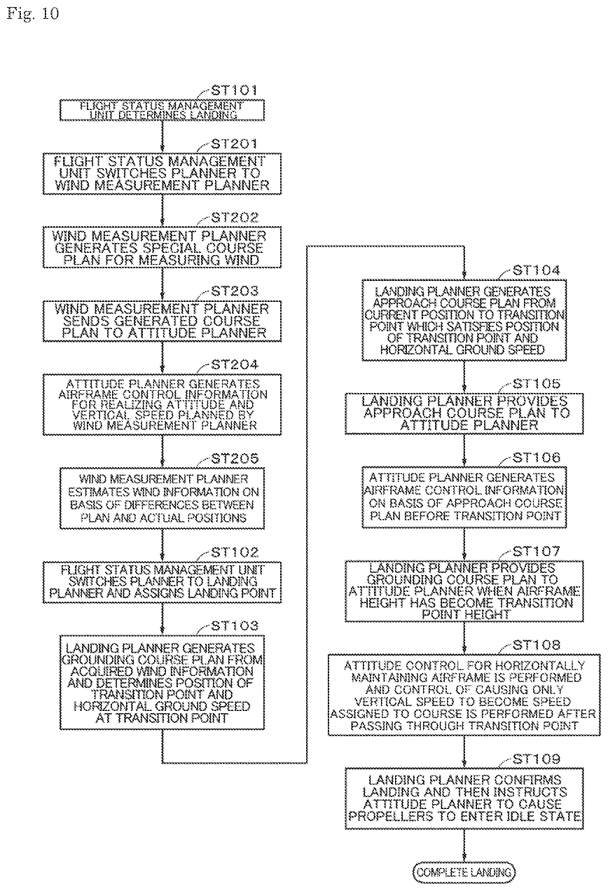

FIG. 10 is a flowchart illustrating a flow of processing performed in the drone 1B. In step ST101, the flight status management unit 101A determines landing as in the first embodiment. Then, processing proceeds to step ST201.

In step ST201, the flight status management unit 101A switches planners from the flight planner 101B to the wind measurement planner 101E. Then, processing proceeds to step ST202.

In step ST202, the wind measurement planner 101E measures the wind and generates a course plan for acquiring wind information. The course plan for acquiring wind information is, for example, information in which chronological positions of the drone 1B, attitudes and speeds at the positions are defined. Then, processing proceeds to step ST203.

In step ST203, the wind measurement planner 101E sends the course plan generated thereby to the attitude planner 101D. Then, processing proceeds to step ST204.

In step ST204, the attitude planner 101D generates airframe control information for realizing the course plan that is planned by the wind measurement planner 101E, specifically, a flight position, an attitude and a speed at the flight position. Then, the attitude planner 101D sends the airframe control information to the airframe control unit 102. The drone 1B flies according to the airframe control unit 102 operating on the basis of the airframe control information. Then, processing proceeds to step ST205.

In step ST205, the wind measurement planner 101E estimates wind information using a known method, for example, on the basis of differences between the course plan for acquiring wind information and positions of the actual drones 1B.

Subsequently to processing of step ST205, processing pertaining to steps ST102 to ST109 is performed. Since the details of processing pertaining to steps ST102 to ST109 have already been described, repeated descriptions will be omitted.

According to the above-described second embodiment, the drone 1B can autonomously generate a course plan for acquiring wind information and acquire the wind information according to the course plan.

### Third Embodiment

Next, a third embodiment will be described. In description of the third embodiment, the same reference numerals are given to the same or homogeneous components as the above-described components and repeated description will be appropriately omitted. Further, the matters described in the first and second embodiments can be applied to the second embodiment unless otherwise mentioned.

The same as the configuration of the drone 1A described in the first embodiment can be applied as a configuration of a drone (hereinafter appropriately referred to as a drone 1C) according to the third embodiment. Although an attitude (horizontal) after the transition point PA is provided as a grounding course plan in the first embodiment, the third embodiment differs from the first embodiment in that a horizontal ground speed from the transition point PA to the landing point LP is provided as a grounding course plan.

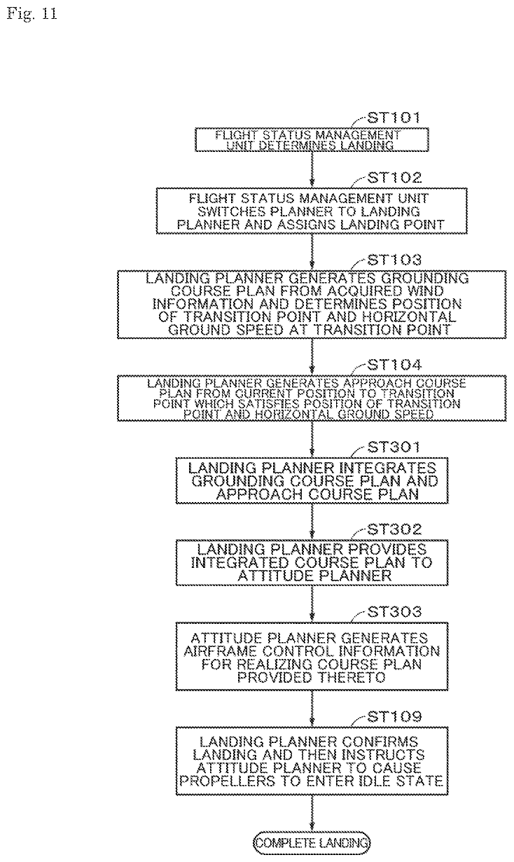

FIG. 11 is a flowchart illustrating a flow of processing performed in the drone 1C. The details of processing pertaining to steps ST101 to ST104 have already been described, and thus repeated descriptions will be omitted. Meanwhile, a horizontal ground speed at the transition point PA and a horizontal ground speed at each position from the transition point PA to the landing point LP are defined in the grounding course plan generated in step ST103 in the present embodiment.

In step ST301 following step ST104, the landing planner 101C integrates the grounding course plan and the approach course plan. Then, processing proceeds to step ST301.

In step ST302, the landing planner 101C provides the integrated course plan to the attitude planner 101D. Then, processing proceeds to step ST303.

In step ST303, the attitude planner 101D generates airframe control information for realizing the course plan provided thereto from the landing planner 101C. Then, the attitude planner 101D outputs the generated airframe control information to the airframe control unit 102. The drone 1C reaches positions, attitudes at the positions, and horizontal ground speeds according to the course plan integrated by the landing planner 101C according to the airframe control unit 102 operating in response to the airframe control information. Then, processing proceeds to step ST109. The details of step ST109 have already been described, and thus repeated descriptions will be omitted.

As described above, according to the third embodiment, it is possible to land the drone 1C in a stable attitude by assigning horizontal ground speeds from the transition point PA to the landing point LP to the drone 1C.

### Fourth Embodiment

Next, a fourth embodiment will be described. In description of the fourth embodiment, the same reference numerals are given to the same or homogeneous components as the above-described components and repeated description will be appropriately omitted. The matters described in the first to third embodiments can be applied to the fourth embodiment unless otherwise mentioned.

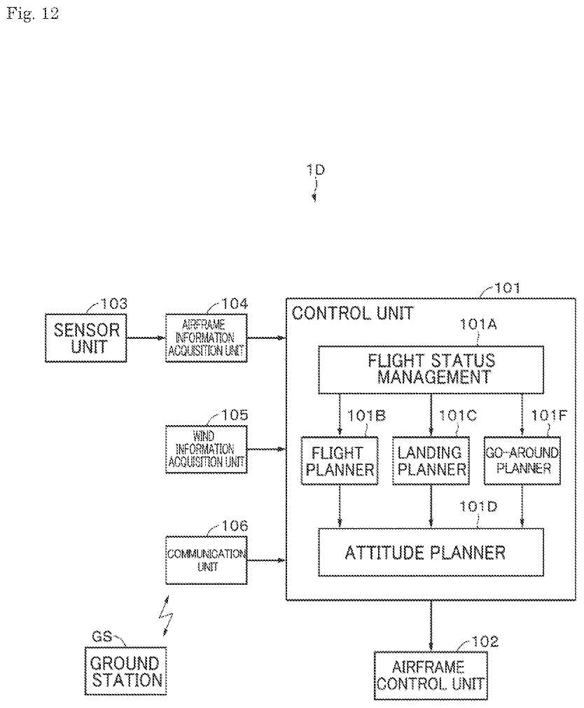

FIG. 12 is a block diagram illustrating a configuration example of a drone (hereinafter appropriately referred to as a drone 1D) according to the fourth embodiment. The drone 1D differs from the drone 1A in that it includes a go-around planner 101F. The go-around planner 101F is a planner that stops landing and causes the drone 1D to ascend to a safe height when an attitude and a horizontal ground speed of the drone 1D at the time of landing do not fall in allowable ranges.

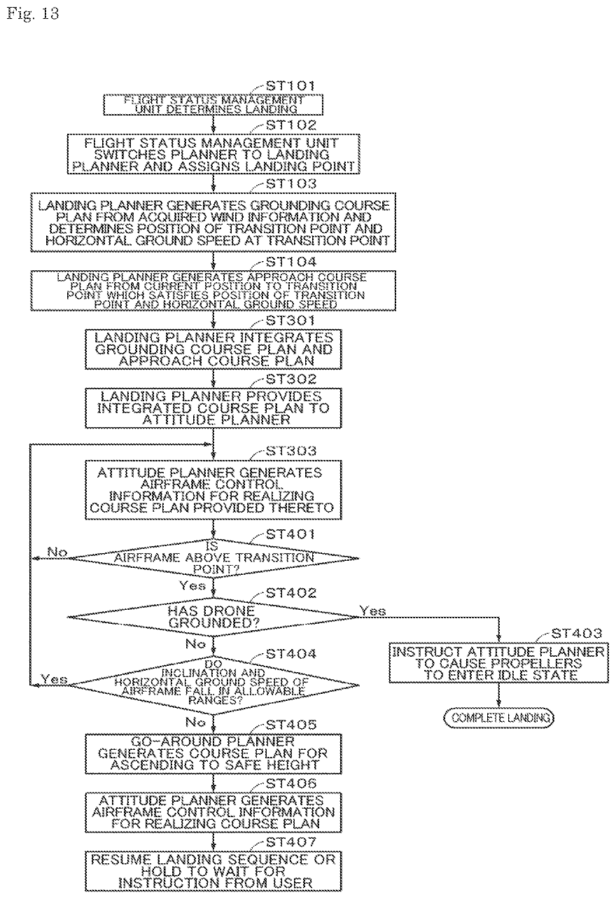

FIG. 13 is a flowchart illustrating a flow of processing performed in the drone 1D. The details of processing pertaining to steps ST101 to ST104 and processing pertaining to ST301 to ST303 have already been described, and thus repeated descriptions will be omitted. Subsequently to processing of step ST303, processing proceeds to step ST401.

In step ST401, it is determined whether the airframe of the drone 1D is above the transition point PA, specifically, the height of the airframe of the drone 1D becomes the transition point PA or lower. Such determination is performed, for example, by the flight status management unit 101A on the basis of sensing data acquired by the sensor unit 103. When the airframe of the drone 1D is not above the transition point PA, processing returns to step ST303. When the airframe of the drone 1D is not above the transition point PA, processing proceeds to step ST402.

In step ST402, it is determined whether the drone 1D has grounded. Such determination is performed, for example, by the flight status management unit 101A on the basis of sensing data acquired by the sensor unit 103. When the flight status management unit 101A determines that the drone 1D has grounded, processing proceeds to step ST403.

In step ST403, the flight status management unit 101A notifies the landing planner 101C that the airframe of the drone 1D has grounded. The landing planner 101C that has received notification instructs the attitude planner 101D to cause propellers of the drone 1A to enter an idle state. The attitude planner 101D generates airframe control information based on such instruction. The attitude planner 101D outputs the generated airframe control information to the airframe control unit 102. The propellers of the drone 1A enter an idle state according to the airframe control unit 102 operating on the basis of the airframe control information. As described above, the idle state means a state in which the propellers of the drone 1A are rotated at a predetermined rotation speed or less (a degree of rotation speed at which the airframe of the drone 1A does not ascend).

When it is determined that the drone 1D has not grounded in determination processing of step ST402, processing proceeds to step ST404.

In step ST404, it is determined whether inclination and a horizontal ground speed of the airframe of the drone 1D fall in allowable ranges. Such determination is performed, for example, by the flight status management unit 101A on the basis of sensing data acquired by the sensor unit 103. Specifically, the flight status management unit 101A determines whether inclination of the airframe is a threshold value or less and determines that the inclination of the airframe falls in an allowable range if the inclination of the airframe is the threshold value or less. In addition, the flight status management unit 101A determines whether a difference between a current horizontal ground speed and a horizontal ground speed defined in the course plan is a threshold value or less and determines that the current horizontal ground speed falls in an allowable range if the difference is the threshold value or less.

If it is determined that the inclination and the horizontal ground speed of the airframe of the drone 1D fall in the allowable ranges, processing returns to step ST303. If it is determined that the inclination and the horizontal ground speed of the airframe of the drone 1D do not fall in the allowable ranges, processing proceeds to step ST405.

In step ST405, the flight status management unit 101A switches planners from the landing planner 101C to the go-around planner 101F. The go-around planner 101F performs control of stopping landing because the inclination and the horizontal ground speed of the airframe of the drone 1D do not fall in the allowable ranges. Specifically, the go-around planner 101F generates a course plan for causing the drone 1D to ascend to a safe height. The go-around planner 101F outputs the generated course plan to the attitude planner 101D. Then, processing proceeds to step ST406.

In step ST406, the attitude planner 101D generates airframe control information for realizing the course plan provided from the go-around planner 101F. Then, the attitude planner 101D outputs the generated airframe control information to the airframe control unit 102. The drone 1D ascends to a safe height according to the airframe control unit 102 controlling rotation speeds of the motors and the like depending on the airframe control information. Then, processing proceeds to step ST407.

In step ST407, the drone 1D that has ascended to the safe height enters a standby state. The flight status management unit 101A of the drone 1D performs, for example, control of resuming a landing sequence (e.g., the above-described processing of steps ST101 to ST104 and processing of steps ST301 and ST302) for landing the drone 1D again. The drone 1D may wait for an instruction from a user.

Meanwhile, although it is determined whether the inclination and the horizontal ground speed of the airframe of the drone 1D fall in the allowable ranges in the present embodiment, it may be determined whether any of the inclination and the horizontal ground speed falls in an allowable range or it may be determined whether other parameters fall in allowable ranges.

According to the above-described fourth embodiment, it is possible to cause the drone 1D to ascend to a safe height when the inclination and the horizontal ground speed of the airframe differ from a plan. Accordingly, it is possible to prevent the drone 1D from failing to land when the drone 1D performs landing operation in an inappropriate attitude.

### Modified Examples

Although embodiments of the present disclosure have been described above in detail, the content of the present disclosure is not limited to the above-described embodiments and various modifications based on the technical spirit of the present disclosure can be made. Hereinafter, modified examples will be described.

Although a configuration in which the control unit includes a plurality of planners has been described in consideration of convenience of description in each embodiment, the present disclosure is not limited thereto. For example, the flight planner and the landing planner may be configured as a single functional block.

A known control method for drones can be applied to the drone in each embodiment.

The present disclosure can also be realized by a device, a method, a program, a system, or the like. For example, by allowing a program that has the functions described in the above-described embodiments to be downloadable and allowing a device that has no functions described in the embodiments to download and install the program, it is possible to perform the control described in the embodiment in the device. The present disclosure can also be realized by a server that distributes the program. In addition, the present disclosure can also be realized as a tool that easily creates a flight plan described in the embodiments. The matters described in each embodiment and the modification examples can be appropriately combined.

Note that the advantageous effect described here is not necessarily limiting, and any advantageous effects described in the present disclosure may be achieved. Further, interpretation of the content of the present disclosure should not be limited by the exemplified advantageous effect.

The present disclosure can also employ the following configurations.

(1)

A flying body including a control unit configured to set a horizontal ground speed on the basis of wind information including information about a wind direction and a wind speed.

(2)

The flying body according to (1), wherein the wind information includes information about wind that affects flight of the flying body.

(3)

The flying body according to (1) or (2), wherein the flying body includes a plurality of motors, and

wherein the control unit controls rotation speeds of the plurality of motors to become the set horizontal ground speed.

(4)

The flying body according to any one of (1) to (3), wherein the horizontal ground speed set by the control unit becomes approximately 0 at a landing point.

(5)

The flying body according to any one of (1) to (4), wherein the control unit controls the rotation speeds of the motors to become the set horizontal ground speed at a point positioned above the landing point.

(6)

The flying body according to (5), wherein the control unit controls an attitude to become approximately horizontal at the point positioned above the landing point.

(7)

The flying body according to (5) or (6), wherein the point positioned above the landing point is a point at which a landing operation starts.

(8)

The flying body according to (7), wherein the control unit performs control of causing an airframe to ascend when at least one of an inclination of the airframe and a horizontal ground speed exceeds an allowable range, during an event from the point at which the landing operation starts to the landing point.

(9)

The flying body according to any one of (5) to (8), wherein the point positioned above the landing point is determined on the basis of at least the horizontal ground speed.

(10)

The flying body according to any one of (1) to (9), including a wind information acquisition unit configured to acquire the wind information.

(11)

The flying body according to (10), wherein the flying body includes a sensor unit, and the wind information acquisition unit calculates and acquires the wind information on the basis of a difference between sensing data acquired by the sensor unit and a motor output.

(12)

The flying body according to (10), wherein the wind information acquisition unit acquires the wind information from an external apparatus.

(13)

A control method in a flying body, including setting, by a control unit, a horizontal ground speed on the basis of wind information including information about a wind direction and a wind speed.

(14)

A program causing a computer to execute a control method in a flying body, including setting, by a control unit, a horizontal ground speed on the basis of wind information including information about a wind direction and a wind speed.

### REFERENCE SIGNS LIST

1A, 1B, 1C, 1D Drone
101 Control unit
101A Flight status management unit
101B Flight planner
101C Landing planner
101D Attitude planner
102 Airframe control unit
103 Sensor unit
105 Wind information acquisition unit
106 Communication unit

1. A flying body comprising a control unit configured to set a horizontal ground speed on the basis of wind information including information about a wind direction and a wind speed.

2. The flying body according to claim 1, wherein the wind information includes information about wind that affects flight of the flying body.

3. The flying body according to claim 1, wherein the flying body includes a plurality of motors, and
wherein the control unit controls rotation speeds of the plurality of motors to become the set horizontal ground speed.

4. The flying body according to claim 1, wherein the horizontal ground speed set by the control unit becomes approximately 0 at a landing point.

5. The flying body according to claim 1, wherein the control unit controls the rotation speeds of the motors to become the set horizontal ground speed at a point positioned above the landing point.

6. The flying body according to claim 5, wherein the control unit controls an attitude to become approximately horizontal at the point positioned above the landing point.

7. The flying body according to claim 5, wherein the point positioned above the landing point is a point at which a landing operation starts.

8. The flying body according to claim 7, wherein the control unit performs control of causing an airframe to ascend when at least one of an inclination of the airframe and a horizontal ground speed exceeds an allowable range, during an event from the point at which the landing operation starts to the landing point.

9. The flying body according to claim 5, wherein the point positioned above the landing point is determined on the basis of at least the horizontal ground speed.

10. The flying body according to claim 1, comprising a wind information acquisition unit configured to acquire the wind information.

11. The flying body according to claim 10, comprising a sensor unit,
wherein the wind information acquisition unit calculates and acquires the wind information on the basis of a difference between sensing data acquired by the sensor unit and a motor output.

12. The flying body according to claim 10, wherein the wind information acquisition unit acquires the wind information from an external apparatus.

13. A control method in a flying body, comprising setting, by a control unit, a horizontal ground speed on the basis of wind information including information about a wind direction and a wind speed.

14. A program causing a computer to execute a control method in a flying body, comprising setting, by a control unit, a horizontal ground speed on the basis of wind information including information about a wind direction and a wind speed.
